(19) United States
(12) Patent Application Publication
(10) Pub. No.: US 2008/0115979 A1
(43) Pub. Date: May 22, 2008

(54) ON-LINE SCALE FOR BOTTLES AND OTHER ITEMS

(75) Inventors: Lewis Roland Shipp, Winston, GA (US); David Dale Bell, Villa Rica, GA (US); Michael Edward LeClerc, Narragansett, RI (US); Hurley Stephen Slusser, Carrollton, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: CONSOLIDATED CONTAINER COMPANY LP, Atlanta, GA (US)

(21) Appl. No.: 11/561,914

(22) Filed: Nov. 21, 2006

(51) Int. Cl. G01G 13/00

(52) U.S. Cl. 177/52

(57) ABSTRACT

An apparatus for weighing a first item in a series of items traveling on a conveyor in which a first item is downstream of a second item in the series of items. The apparatus may comprise: (1) a scale; (2) an item repositioning mechanism that is adapted to move (e.g., slide) the first item from the conveyor into weighing engagement with the scale; and (3) a braking mechanism that is adapted to limit the forward progress of the second item while the item repositioning mechanism moves the first item from the conveyor into weighing engagement with the scale, and to thereby prevent the second item from passing the first item while the first item is in weighing engagement with the scale. In other embodiments, the braking mechanism may release to allow the second item to pass the first item while the first item is in weighing engagement with the scale.

### BACKGROUND OF THE INVENTION

In blow molding operations for the production of bottles, it is often desirable to periodically weigh sample bottles after they are produced on a manufacturing line. This information may be used to determine whether too much or too little resin is being used in each bottle. If the bottles are being produced with too little resin, the bottles may not satisfy agreed-upon bottle specifications. On the other hand, if the bottles are being produced with too much resin, the production cost associated with each bottle may be higher than necessary due to the extra resin content of the bottles. Accordingly, operators may use the information obtained from weighing the bottles to make any adjustments necessary to ensure that the manufacturing process is cost-efficient and results in the production of compliant bottles.

Currently, it is common for production operators to periodically weigh sample bottles selected from a manufacturing line by hand. This process is inefficient and labor intensive. Some automated item weighing mechanisms also exist, but these mechanisms are often expensive and difficult to add to existing manufacturing lines. These current item weighing mechanisms typically also require extensive modifications in the event of a product changeover (in which the manufacturing line is modified to produce a different bottle). Accordingly, there is a need for improved weighing mechanisms (for bottles or other items) that address one or more of the problems noted above.

### SUMMARY OF VARIOUS EMBODIMENTS OF THE INVENTION

Various embodiments of the invention are directed to an item weighing apparatus for weighing a first item in a series of items traveling on a conveyor in which a first item is downstream of a second item of the series of items (e.g., relative to the conveyor's direction of motion). In various embodiments, the item weighing apparatus comprises: (1) a scale; (2) an item repositioning mechanism that is adapted to move the first item from the conveyor into weighing engagement with the scale; and (3) a braking mechanism that is adapted to limit the forward progress of the second item while the item repositioning mechanism moves the first item from the conveyor into weighing engagement with the scale, and to thereby prevent the second item from passing the first item while the first item is in weighing engagement with the scale.

In other embodiments, the first and second items are in an immediate sequential relationship to each other on the conveyor; and the item weighing apparatus comprises: (1) a scale comprising a weighing surface, the scale being adapted to weigh one or more items disposed on the weighing surface; and (2) an item repositioning mechanism that is adapted for: (A) sliding the first item from a position adjacent a top surface of the conveyor onto a weighing surface of the scale; and (B) after the scale weighs the first item, sliding the first item from the weighing surface of the scale back to a position adjacent the top surface of the conveyor. In particular embodiments, the system is adapted to prevent the second item from passing the first item while: (A) the item repositioning mechanism slides the first item from a position adjacent a top surface of the conveyor onto a weighing surface of the scale; (B) the scale weighs the first item; and/or (C) the item repositioning mechanism slides the first item from the weighing surface of the scale back to a position adjacent the top surface of the conveyor.

Particular embodiments of the invention are directed to a method of weighing a first item in a series of items traveling on a conveyor, wherein the first item is downstream of a second item of the series of items, relative to a direction of motion of the conveyor. In various embodiments, the method comprises the steps of: (A) restricting the forward movement of the second item; and (B) while restricting the forward movement of the second item: (1) diverting the first item from the conveyor so that the first item is in weighing engagement with a scale; (2) after the step of diverting the first item so that the first item is in weighing engagement with a scale, and while the first item is in weighing engagement with the scale, weighing the first item; and (C) after the step of weighing the first item, moving the first item back onto the conveyor.

### BRIEF DESCRIPTION OF THE DRAWINGS

Having thus described the invention in general terms, reference will now be made to the accompanying drawings, which are not necessarily drawn to scale, and wherein:

FIGS. 1-30 are top schematic views of an on-line item weighing apparatus according to a particular embodiment of the invention. These figures are sequential depictions of the apparatus as it weighs and replaces a particular container (Container “D”) within a series of containers, and then begins the process of moving a second container (Container “E”) into position for later transfer onto the weighing apparatus' scale. These drawings include various sensors that, when activated, are shown with a dark solid fill and that, when not activated, are shown with a light solid fill.

### DETAILED DESCRIPTION OF VARIOUS EMBODIMENTS OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

### Overview

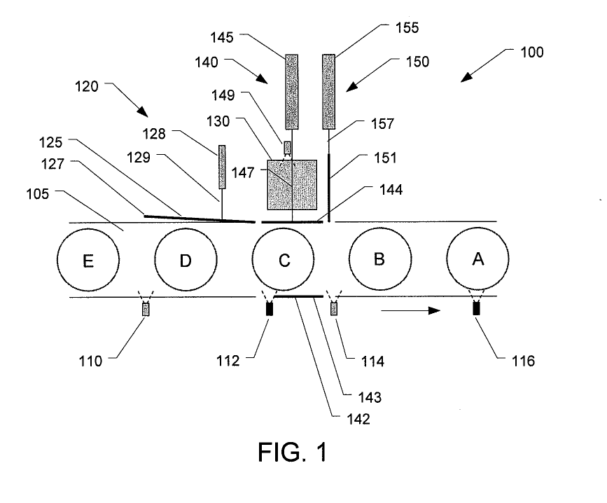

An item weighing apparatus according to a particular embodiment of the invention is shown in FIG. 1. As may be understood from this figure, in various embodiments, the weighing apparatus 100 includes: (1) a braking mechanism 120 that is adapted to selectively stop (or otherwise inhibit) the forward progress of one or more items (e.g., items A-E) traveling along a conveyor 105 (which may, for example, be a belt conveyor, or other suitable type of conveyor); (2) a scale 130 that is positioned adjacent the conveyor 105 and that is adapted to weigh one or more of the items A-E; (3) an item repositioning mechanism 140 that is adapted to move items (a) from the a top surface of the conveyor 105 to a weighing surface of the scale 130; and (b) from the weighing surface of the scale 130 back onto the conveyor 105; (4) a stop mechanism 150 that is adapted to selectively prevent items from moving past a certain position (e.g., from moving substantially past the item repositioning mechanism 140; (5) a plurality of sensors 110, 112, 114, 116, 149 that are adapted for detecting the presence of one or more items; these sensors are preferably mounted at various points along the conveyor 105 and adjacent the scale 130; (6) a control system (not shown) for controlling the movement of the various components described above (e.g., in response to information obtained from the sensors); and (7) memory for storing weight information obtained from the scale 130. The structure and operation of the above components is described in greater detail below.

### Braking Mechanism

FIG. 1 shows a braking mechanism 120 according to a particular embodiment of the invention. In various embodiments, the braking mechanism 120 is adapted to selectively stop (or otherwise inhibit) the forward progress of one or more items (e.g., items A-E) traveling along a conveyor 105. In the embodiment of the invention shown in FIG. 1, the braking mechanism 120 is mounted adjacent a lateral side of a conveyor 105 on which a series of items are traveling in a particular direction (which is indicated by the horizontal arrow shown in FIG. 1).

In a particular embodiment, the braking mechanism 120 includes a brake 125 that may, for example, be substantially planar and that may be mounted so that a front face of the brake 125 is in a substantially vertical orientation and faces items traveling on the conveyor 105 past the brake mechanism 120. The brake 125 is pivotably mounted adjacent the conveyor 105 so that the brake 125 may selectively pivot about a pivot point 127 that is disposed adjacent an upstream end of the brake 125.

The braking mechanism 120 of FIG. 1 further includes a linear brake actuator 128 that includes a base portion and brake actuator rod 129 that extends between the brake actuator's base portion and a portion of the brake 125 that is spaced apart (e.g., downstream) from the brake actuator's pivot point 127. The braking mechanism 120 is preferably configured so that when the brake actuator rod 129 is extended away from the brake actuator's base portion, the brake 125 extends into a braking position in which the brake 125 is at least partially in the path of items traveling on the conveyor 105. This preferably serves to prevent (or otherwise inhibit) items of a predetermined size from traveling past the braking mechanism 120 on the conveyor 105.

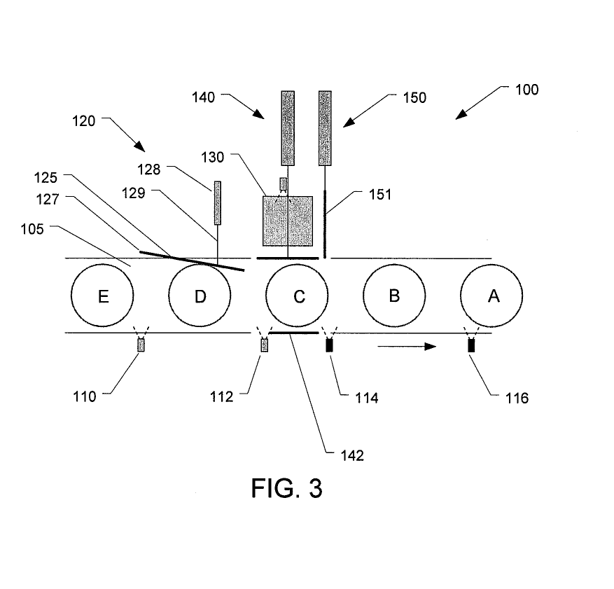

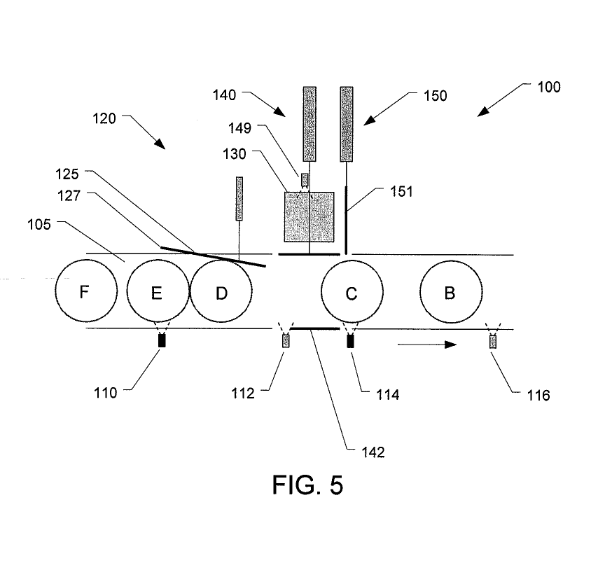

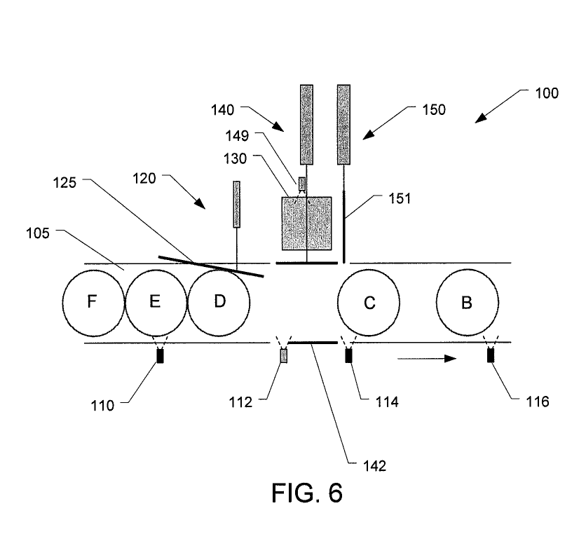

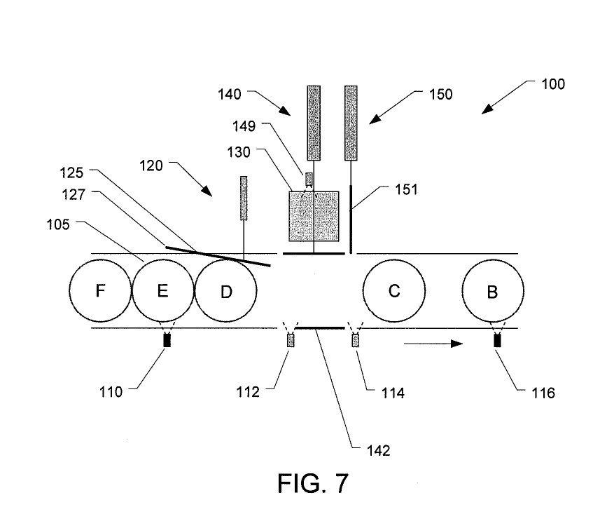

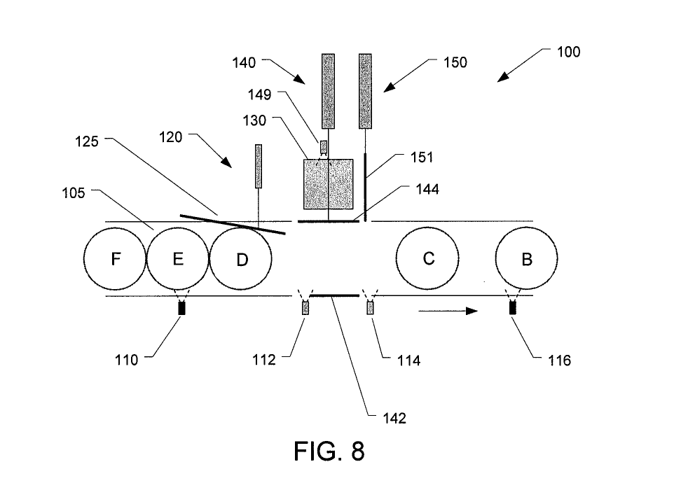

For example, in FIGS. 3-8, the brake 125 is shown in a braking position in which the brake 125 extends partially into the path of a particular item D traveling on the conveyor 105. In the embodiment shown in FIG. 3, the brake 125 forms an acute angle with the conveyor's direction of travel. Also, in this embodiment, when the brake 125 is in the braking position shown in FIG. 3, the brake 125 cooperates with a skid plate (not shown) that is positioned across the conveyor from the brake 125 (e.g., immediately adjacent a lateral side of the conveyor) to form a wedge structure. This wedge structure is preferably adapted to capture and stop items of a predetermined size as they travel on the conveyor 105 adjacent the brake mechanism 130.

In a particular embodiment, when the brake 125 is in a disengaged orientation (see FIG. 1), the brake 125 does not substantially inhibit the motion (e.g., the forward motion) of items traveling adjacent the braking mechanism 120 on the conveyor 105.

### Scale

In particular embodiments of the invention, the item weighing apparatus 100 includes a scale 130 that is positioned adjacent the conveyor 105 and that is adapted to weigh one or more items traveling on the conveyor 105 (e.g., items A-E) when the items are positioned on a weighing surface of the scale 130. The scale 130 is preferably positioned so that the scale's weighing surface (which is preferably a substantially planar, substantially horizontal surface) is at about the same height as the upper surface of the conveyor 105. This serves to facilitate sliding items from the conveyor's upper surface to the scale's weighing surface.

In particular embodiments, the scale 130 is positioned so that the scale's weighing surface is immediately adjacent a lateral side of the conveyor 105. In other embodiments, the scale 130 is positioned so that the scale's weighing surface is spaced apart from a lateral side of the conveyor 105. In such an embodiment, a substantially planar, substantially horizontal, low-friction “slide plate” may be positioned so that it extends between the conveyor's upper surface 105 and the scale's weighing surface. The slide plate preferably provides a low-friction bridge between the conveyor's upper surface 105 and the scale's weighing surface.

### Item Repositioning Mechanism

In various embodiments, the item weighing apparatus 100 further includes an item repositioning mechanism 140 that is adapted for moving items: (A) from the top surface of the conveyor 105 to a weighing surface of the scale 130; and (B) from the weighing surface of the scale 130 back onto the top surface of the conveyor 105. In particular embodiments, the item repositioning mechanism 140 includes an item positioning assembly 142 that includes a first wall 143 (which is preferably a substantially planar, substantially vertical wall), and a second wall 144 (which is also preferably a substantially planar, substantially vertical wall). As shown in FIG. 1, in particular embodiments, the first and second walls 143, 144 are positioned so that they are co-facing and spaced apart from each other, and so that: (A) the first wall 143 is positioned adjacent a first lateral side of the conveyor 105; and (B) the second wall 144 is positioned adjacent a second lateral side of the conveyor 105.

In various embodiments, a substantially horizontal bridge portion (not shown) extends from a top surface of the first wall 143 to a top surface of the second wall 144. Accordingly, in such an embodiment, the item positioning assembly 142 is substantially U-shaped and inverted. In other embodiments, one or more other types of structural members are used to maintain the second wall 144 in a pre-determined spaced-apart relationship with the first wall 143. However, it should be understood that, in alternative embodiments, the first and second walls 143, 144 may be adapted to move relative to one another.

As shown in FIG. 1, in particular embodiments, the item repositioning mechanism 140 includes a base portion 145 and an actuator rod 147 that serve as a liner actuator for moving the item positioning assembly 142 relative to both the scale 130 and a top surface of the conveyor 105 that is adjacent the scale 130. In particular embodiments, the actuator rod 147 is adapted for moving the item positioning assembly 142 laterally relative to the top surface of the conveyor 105.

### Stop Mechanism

In particular embodiments, the item weighing apparatus 100 includes a stop mechanism 150 that is adapted to selectively prevent items from moving past a pre-determined position on the conveyor 105 (e.g., from moving substantially past the item positioning assembly 142). In particular embodiments, the stop mechanism 150 comprises a substantially planar, substantially vertically-oriented stop 151 that is preferably oriented so that it is substantially perpendicular to the conveyor's direction of travel.

In various embodiments, the stop mechanism 150 further comprises an actuator that is adapted for selectively moving the stop 151 into (and out of) the path of items traveling on the conveyor 105. For example, in the embodiment shown in FIG. 1, the stop mechanism 150 comprises a base portion 155 and a stop actuator rod 157. In this embodiment, the stop mechanism 150 is adapted to move the stop 151 relative to the base portion 155 of the stop mechanism 150 via the stop actuator rod 157.

### Sensors

As noted above, in particular embodiments, the item weighing apparatus 100 includes a plurality of sensors 110, 112, 114, 116, 149, each respective one of which is adapted for detecting the presence of one or more items adjacent the respective sensor. In one embodiment, the item weighing apparatus 100 includes: (1) a first sensor 110 that is positioned to sense the presence of items moving on the conveyor 105 immediately adjacent the braking mechanism 120; and (2) a second sensor 112 that is positioned to sense the presence of items moving on the conveyor 105 as they begin to pass between the item repositioning mechanism's first and second walls 143, 144; (3) a third sensor 114 that is positioned to sense the presence of items moving on the conveyor 105 as they begin to move past the item repositioning mechanism's first and second walls 143, 144; (4) a fourth sensor 116 that is positioned to sense the presence of items downstream of the third sensor 114 (relative to the motion of the conveyor); and (5) a fifth (“scale”) sensor 149 that is positioned to sense the presence of items on the scale 130. It should be understood that, in other embodiments of the invention, the item weighing apparatus 100 may include more or fewer sensors than those described above.

### Control System/Memory

In particular embodiments, the item weighing apparatus 100 includes a control system (e.g., a computerized control system comprising at least one computer processor and a memory for storing computer-executable instructions to be executed by the at least one computer processor). In particular embodiments, the control system is adapted for controlling the operation of the braking mechanism 120, the scale 130, the item repositioning mechanism 140, and/or the stop mechanism 150. In particular embodiments, the control system is adapted for receiving data from the item weighing apparatus' various sensors 110, 112, 114, 116, 149 and for controlling the operation of the braking mechanism 120, the scale 130, the item repositioning mechanism 140, and the stop mechanism 150 based, at least in part, on information obtained from the item weighing apparatus' various sensors 110, 112, 114, 116, 149. The operation of various embodiments of the item weighing apparatus 100 is described below.

### Operation of Exemplary Item Weighing Apparatus

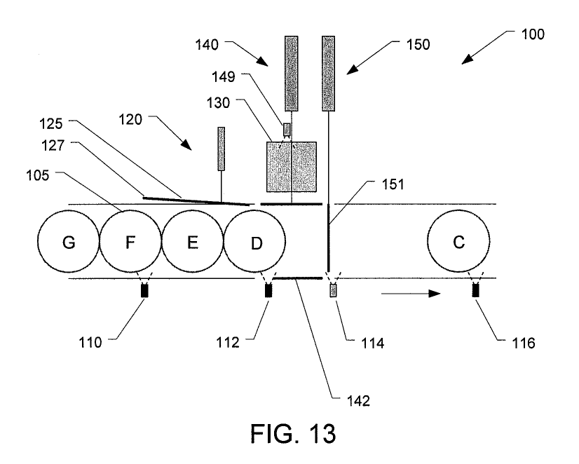

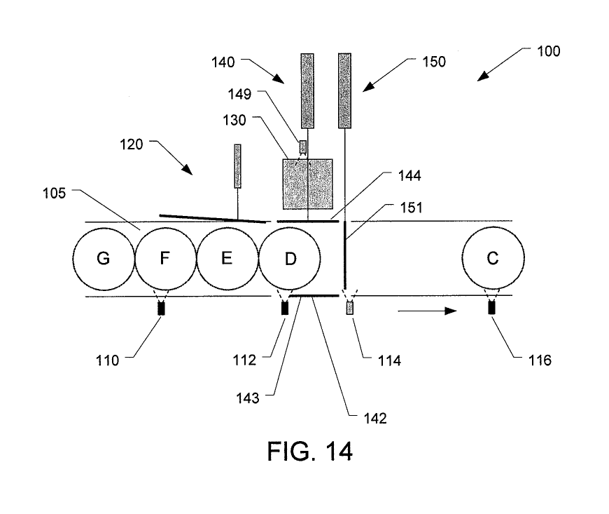

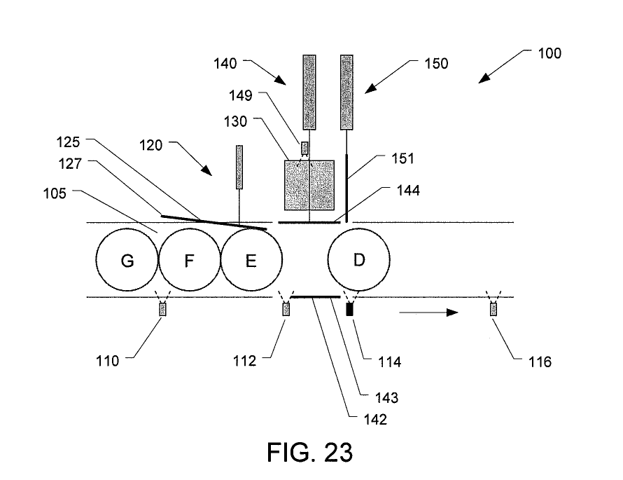

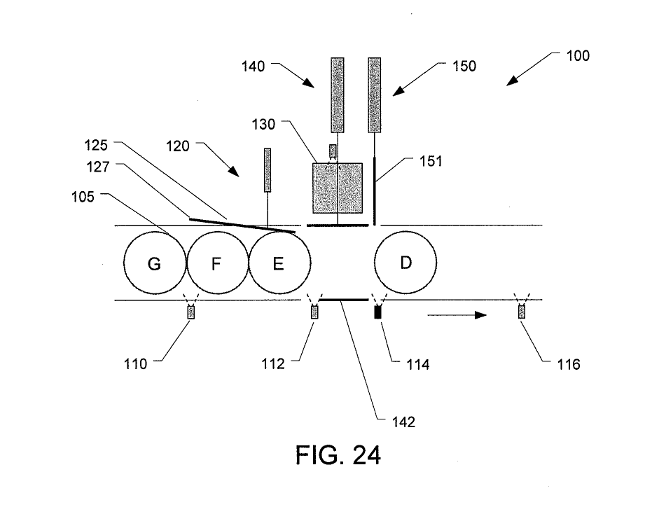

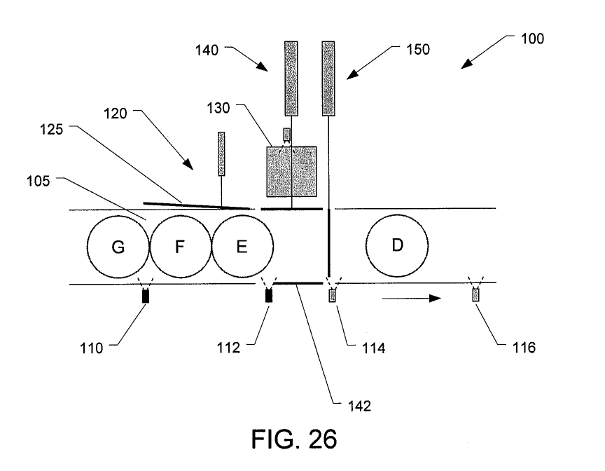

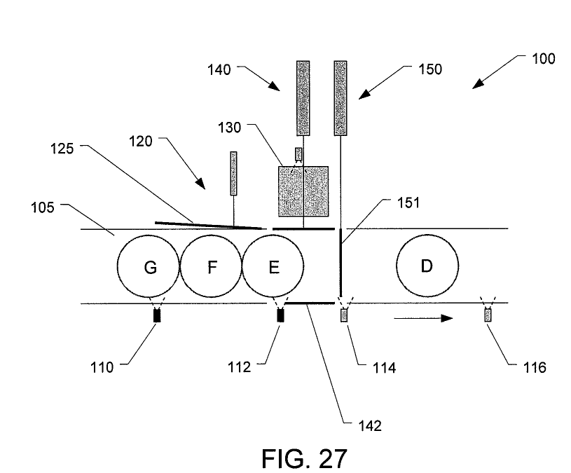

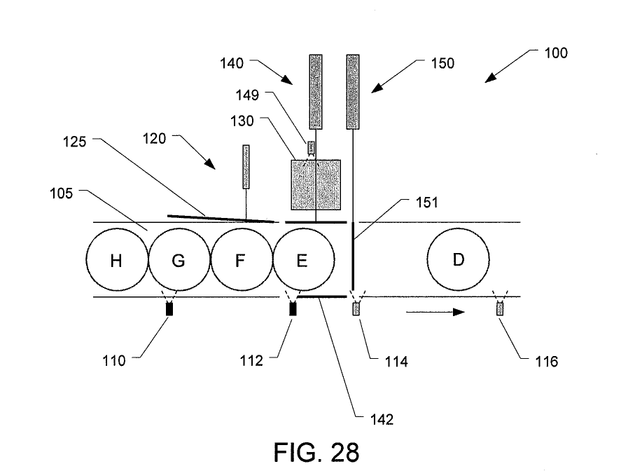

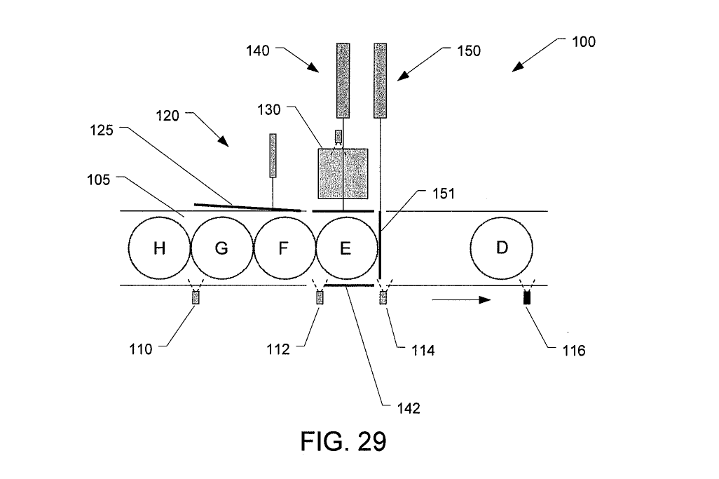

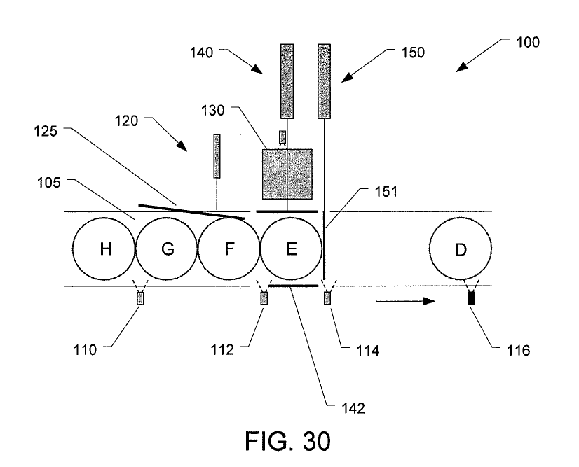

The operation of an item weighing apparatus 100 according to a particular embodiment of the invention is shown in FIGS. 1-30, which depict the sequential flow of this embodiment of the invention. Beginning with FIG. 1, the item weighing apparatus 100 allows items A-E traveling on a conveyor 105 to freely pass by the braking mechanism 120, the item positioning assembly 142, and the stop mechanism 150. In the meantime, each particular one of the item weighing apparatus' first, second, third, and fourth sensors 110, 112, 114, 116 determine when an item passes adjacent the particular sensor, and transmits this information to the item weighing apparatus' control system for use in controlling the operation of the item weighing apparatus 100. For example, in the configuration shown in FIG. 1, the item weighing apparatus' second and fourth sensors 112, 116 are activated (as indicated by the fact that these sensors are shown with a dark solid fill—this annotation is repeated throughout FIGS. 1-30), and the first and third sensors 110, 114 are not activated (as indicated by the fact that these sensors are shown with a light solid fill—this annotation is repeated throughout FIGS. 1-30). In FIGS. 1-30, the conveyor's belt is continuously moving in the direction of the horizontal arrow shown in FIG. 1.

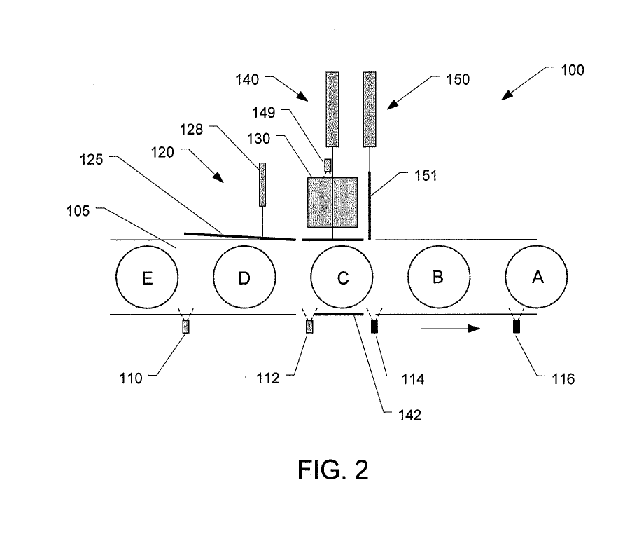

As shown in FIG. 2, the control system continues to use the sensors 110, 112, 114, 116, and 149 to monitor the position of items on the conveyor 105. Next, as shown in FIG. 3, when the control system determines that it is time to weigh an item traveling on the conveyor 105 (which may be done according to any appropriate algorithm), the control system activates the brake actuator 128, which pivots the brake 125 about its pivot point 127 into a braking position in which the brake 125 prevents items of a pre-determined size (e.g., the size of the items traveling on the conveyor 105) from moving past the braking mechanism 120. This causes the next item that is upstream of the brake 125 (in this case, item D) to stop adjacent the brake 125 due to: (1) friction between a first lateral side of the item D and the brake 125; and (2) friction between a second lateral side of the item D and a skid plate (not shown) that is spaced apart from, and across the conveyor 105 from, the braking mechanism 130.

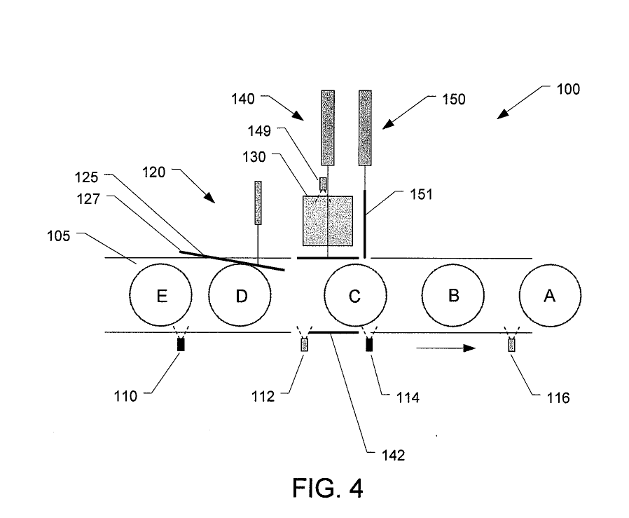

Next, as shown in FIGS. 4-8, the control system maintains the brake 125 in the braking position while additional items “pile up” in back of item D due to the continuous forward motion of the conveyor 105 (which passes beneath items D-F as item D is held in place by the braking mechanism 120) and frictional forces between the conveyor 105 and the bottom surfaces of items D-F. The braking mechanism 120 and the conveyor 105 thus serve to maintain a closely packed, in-line row of items D-F immediately behind the brake 125.

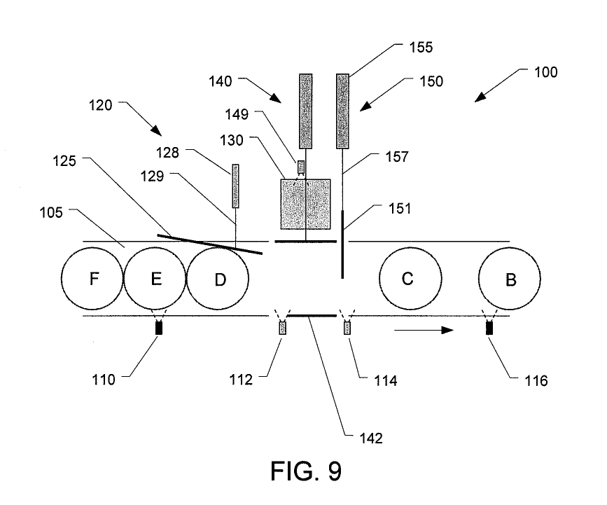

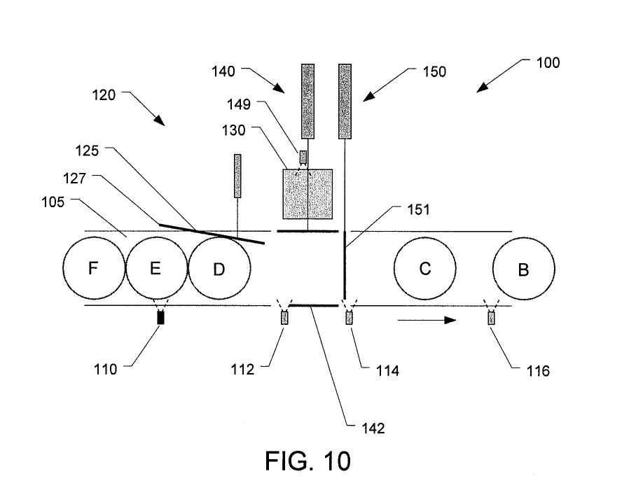

Next, as shown in FIGS. 9 and 10, in response to the second and third sensors 112, 114 indicating that no items are adjacent the item repositioning mechanism 140, the control system causes the stop mechanism 150 to move the stop 151 into the path of items traveling on the conveyor 105. This prevents the movement of items of a pre-determined size (e.g., the size of standard items traveling on the conveyor 105) from moving past the stop 151.

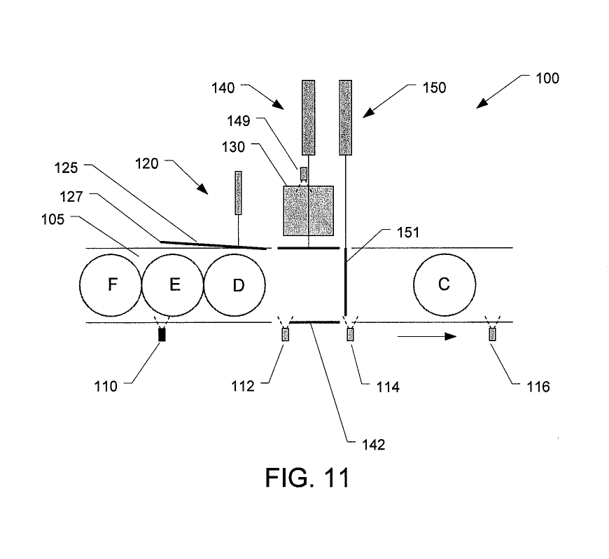

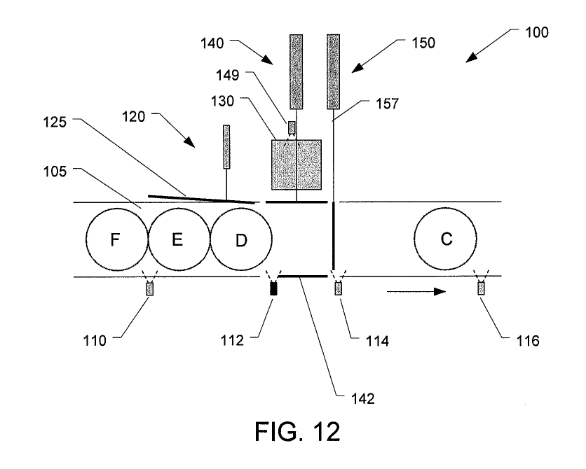

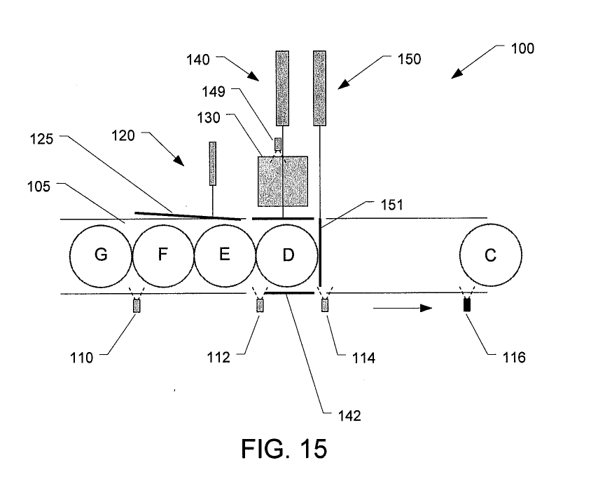

As shown in FIGS. 11-15, the control system then causes the brake actuator 128 to move the brake 125 into a disengaged orientation in which the brake 125 no longer substantially obstructs the forward movement of items (e.g., items D-G) traveling on the conveyor 105. As shown in FIGS. 12-14, this allows item D to move forward until item D engages the stop 151. In this position, item D is positioned between the item positioning assembly's first and second walls 143, 144. As shown in FIGS. 12-15, during this process, the second sensor 112 activates as item D moves toward the item positioning assembly's first and second walls 143, 144. The second sensor 112 then deactivates when item D is positioned between the item positioning assembly's first and second walls 143, 144, as shown in FIG. 15. In various embodiments, this information is used by the control system to determine when an item to be weighed (here, item D) is positioned between the item positioning assembly's first and second walls 143, 144.

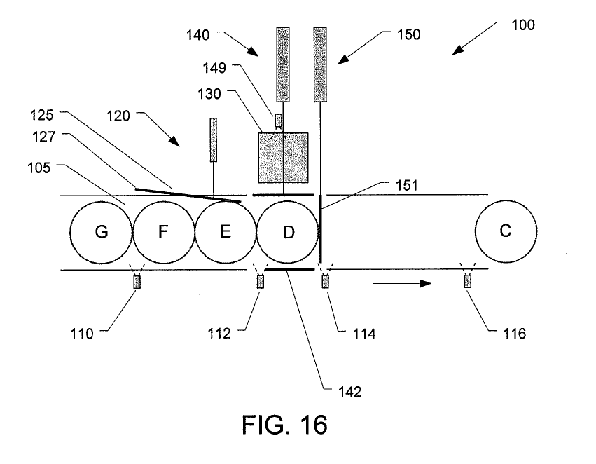

Next, in response to the control system determining (e.g., via information obtained from the second sensor 112) that an item (here, item D) has moved into contact with the stop 151 and is positioned between the item positioning assembly's first and second walls 143, 144, as shown in FIGS. 15 and 16, the control system causes the brake 125 to move back into the braking position. This serves to prevent the forward movement of the item (here, item E) that is immediately upstream of the item (here, item D) that is engaging the stop 151.

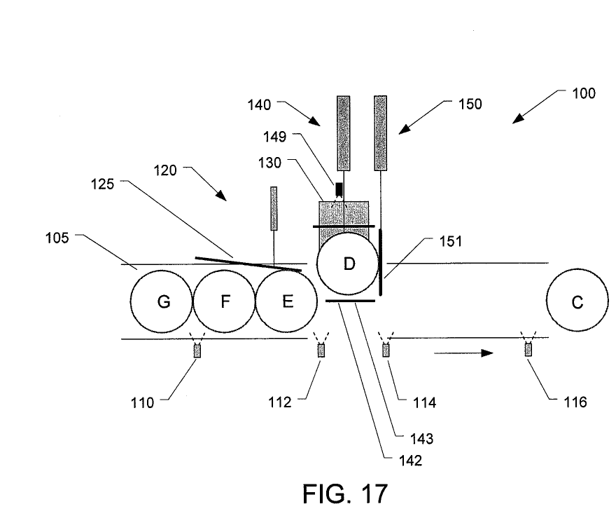

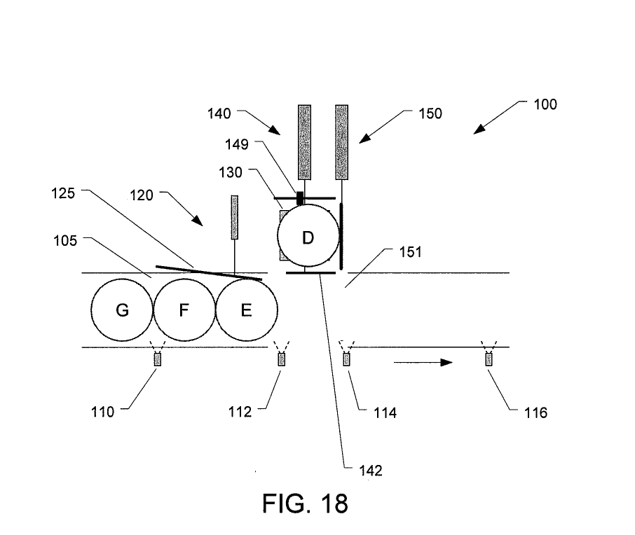

Next, while maintaining the brake 125 in the braking position, the control system causes the item repositioning mechanism 140 to move the item positioning assembly 142 toward the scale 130. As a result, the first wall 143 of the item positioning assembly 142 engages a lateral side of item D and slides item D onto the scale's weighing surface (see FIGS. 17 and 18).

In response to item D being moved onto the scale's weighing surface, the scale sensor 149 is activated which, in turn, causes the control system to take a weight reading from the scale 130. This weight reading reflects the weight of item D.

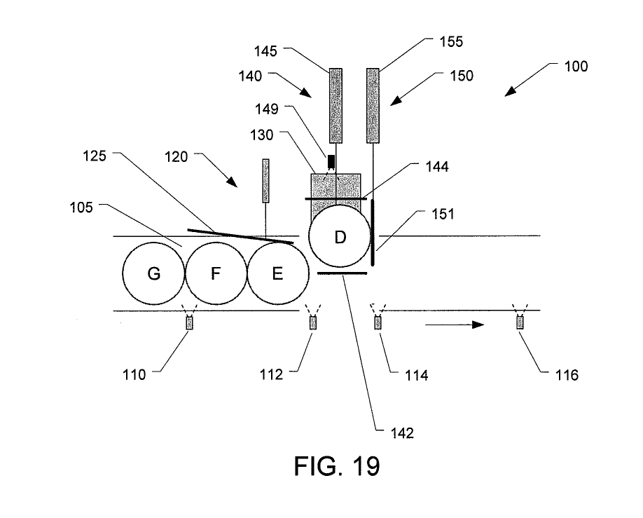

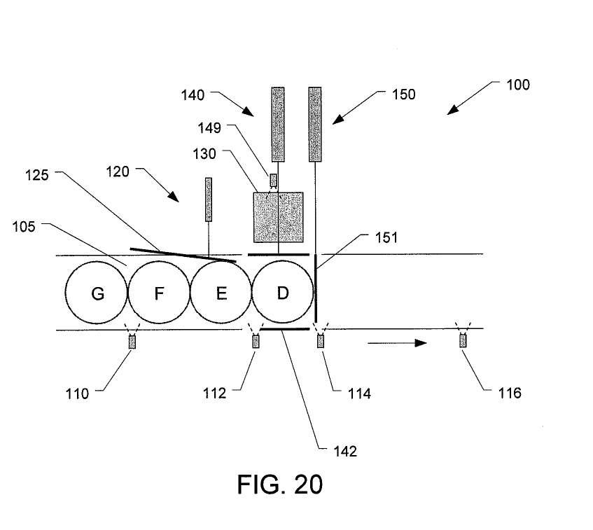

As shown in FIGS. 19 and 20, after item D is weighed, the control system causes the item repositioning mechanism 140 to slide item D from the scale's weighing surface back onto the conveyor 105. This is preferably done while maintaining the brake 125 in the braking position, and the stop 151 in a position in which it blocks the path of items traveling on the conveyor 105.

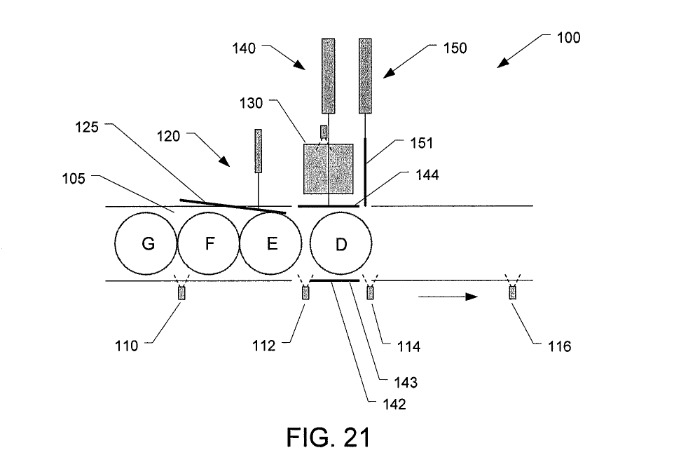

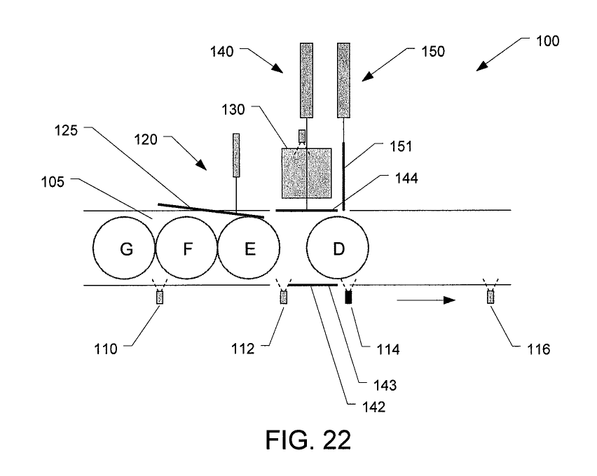

In response to the control system determining that the weighed item (here, item D) has been placed back onto the conveyor 105 (which may be determined based on the movement of the item positioning assembly 142), the control system moves the stop 151 into a retracted position in which the stop 151 does not substantially obstruct the path of items traveling on the conveyor 105 (see FIGS. 20 and 21). This allows the weighed item (here, item D) to travel forward along the conveyor 105, and past the stop mechanism 150 (see FIGS. 22-24).

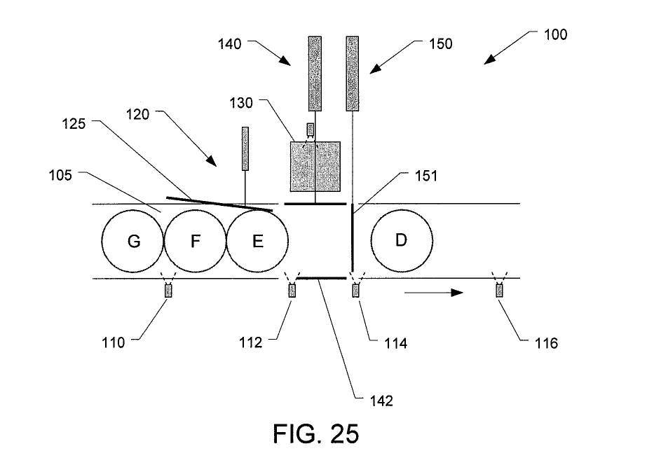

Next, the system may weigh the immediate next upstream item (here, item E) by simply repeating the techniques described above in regard to item D for item E. This process is shown (up to the point at which item E is positioned between the first and second walls 143, 144 of the item positioning assembly 142) in FIGS. 25-30.

### Sequence of Items

As may be understood from the above example, various embodiments of the item weighing apparatus 100 may be used to weigh items while maintaining their original relative positions on the conveyor 105 (e.g., without changing the original order of the items on the conveyor 105). However, it should be understood that similar techniques may be used to allow items upstream of a particular item that is being weighed to pass the particular item as it is being weighed by the item weighing apparatus 100. This may be done, for example, by simply moving the brake 125 and stop 151 out of the path of items traveling on the conveyor 105 as the particular item is being weighed.

In this “pass through” embodiment, before moving the weighed item from the scale 130 onto the conveyor 105, the control system may move the brake 125 into the braking position and use the second and third sensors 112, 114 to determine when all items have moved out of the lateral path of the item positioning assembly 142. In response to making this determination, the control system may then cause the item positioning assembly 142 to move the weighed item back onto the conveyor 105. This technique serves to prevent the item repositioning mechanism 140 from pushing items off of the conveyor 105 as the item repositioning mechanism 140 moves weighed items onto the conveyor 105.

### Use of Data

In various embodiments of the invention, in response to receiving weight data for a particular item from the scale 130, the control system saves this weight data (e.g., along with an appropriate date and time stamp) in a memory (e.g., within a database) associated with the item weighing apparatus 100. In various embodiments, this information may be used to adjust machinery producing the items so that the weight of the items is within a target weight range. This weight information may also be used later to evaluate the performance of the operators who are operating the machinery.

### Types of Items Weighed

The above techniques are especially useful in the production of lightweight plastic items, such as plastic containers. However, it should be understood that such techniques may be used in conjunction with a wide variety of other items, such as food items.

### CONCLUSION

Many modifications and other embodiments of the invention will come to mind to one skilled in the art to which this invention pertains having the benefit of the teachings presented in the foregoing descriptions and the associated drawings. Accordingly, it should be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

What is claimed is:

1. An item weighing apparatus for weighing a first item in a series of items traveling on a conveyor, wherein:
said first item is downstream, relative to a direction of motion of said conveyor, of a second item of said series of items; and
said item weighing apparatus comprises:
a scale;
an item repositioning mechanism that is adapted to move said first item from said conveyor into weighing engagement with said scale; and
a braking mechanism that is adapted to limit the forward progress of said second item while said item repositioning mechanism moves said first item from said conveyor into weighing engagement with said scale, and to thereby prevent said second item from passing said first item while said first item is in weighing engagement with said scale.

2. The item weighing apparatus of claim 1, wherein:
said scale is adapted to weigh said first item while said first item is in weighing engagement with said scale; and
said item repositioning mechanism is adapted to move said first item out of weighing engagement with said scale and back onto said conveyor after said scale weighs said first item.

3. The item weighing apparatus of claim 2, wherein:
said item repositioning mechanism is adapted to move said first item out of weighing engagement with said scale and back onto said conveyor in response to said scale weighing said first item.

4. The item weighing apparatus of claim 2, wherein said braking mechanism is adapted to limit the forward progress of said second item while said item repositioning mechanism moves said first item out of weighing engagement with said scale and back onto said conveyor, and to thereby prevent said second item from passing said first item while said first item is being moved out of weighing engagement with said scale and back onto said conveyor.

5. The item weighing apparatus of claim 4, wherein said braking mechanism is adapted to stop limiting the forward progress of said second item in response to said first item being moved back onto said conveyor.

6. The item weighing apparatus of claim 5, wherein said braking mechanism is adapted to limit the forward progress of said second item while said item repositioning mechanism moves said first item from said conveyor into weighing engagement with said scale by physically restricting the forward movement of said second item while said conveyor continues moving relative to said second item.

7. The item weighing apparatus of claim 6, wherein said braking mechanism is adapted to limit the forward progress of said second item while said item repositioning mechanism moves said first item from said conveyor into weighing engagement with said scale by exerting opposing forces on opposite sides of said second item while said conveyor continues moving relative to said second item, and
said opposing forces serve to maintain said second item in a substantially fixed position relative to said conveyor as said conveyor moves relative to said second item.

8. The item weighing apparatus of claim 7, wherein said first and second items are plastic containers.

9. The item weighing apparatus of claim 1, wherein:
said first and second items are downstream of a third item in said series of items on said conveyor; and
said braking mechanism is adapted to simultaneously limit the forward progress of said second and third items while said item repositioning mechanism moves said first item from said conveyor into weighing engagement with said scale, and to thereby prevent said second and third items from passing said first item while said first item is in weighing engagement with said scale.

10. The item weighing apparatus of claim 1, wherein:
said item repositioning mechanism is adapted to slide said first item from said conveyor into weighing engagement with said scale by sliding said first item onto a weighing surface of said scale.

11. The item weighing apparatus of claim 1, wherein said first and second items are plastic containers.

12. The item weighing apparatus of claim 1, wherein said braking mechanism is adapted to stop said second item and to thereby prevent said second item from passing said first item while said first item is in weighing engagement with said scale.

13. The item weighing apparatus of claim 1, wherein said braking mechanism is adapted to limit the forward progress of said second item while said item repositioning mechanism moves said first item from said conveyor into weighing engagement with said scale by physically restricting the forward movement of said second item while said conveyor continues moving relative to said second item.

14. The item weighing apparatus of claim 1, wherein said item repositioning mechanism is adapted to begin moving said first item from said conveyor into weighing engagement with said scale while said first item and second items are positioned in an immediate sequential relationship on said conveyor.

15. The item weighing apparatus of claim 1, wherein said item repositioning mechanism is adapted to move said first item laterally from said conveyor into weighing engagement with said scale.

16. The item weighing apparatus of claim 1, wherein said item weighing apparatus further comprises a stop that is adapted to stop the forward movement of the first item immediately before said repositioning mechanism moves said first item from said conveyor into weighing engagement with said scale.

17. The item weighing apparatus of claim 16, wherein:
said braking mechanism is adapted to simultaneously brake said first and second items as said items approach said scale on said conveyor, and then to stop braking said first and second items immediately before said stop stops the forward movement of said first item

18. The item weighing apparatus of claim 17, wherein:
said braking mechanism is adapted to brake said second item as said stop stops the forward movement of said first item.

19. An item weighing apparatus for weighing a first item in a series of items traveling on a conveyor, wherein:
said first item is downstream, relative to a motion of said conveyor, of a second item of said series of items on said conveyor;
said first and second items are in an immediate sequential relationship to each other on said conveyor; and
said item weighing apparatus comprises:
a scale comprising a weighing surface, said scale being adapted to weigh one or more items disposed on said weighing surface, and
an item repositioning mechanism that is adapted for: (A) sliding said first item from a position adjacent a top surface of said conveyor onto a weighing surface of said scale; and (B) after said scale weighs said first item, sliding said first item from said weighing surface of said scale back to a position adjacent said top surface of said conveyor; and
said system is adapted to prevent said second item from passing said first item while: (A) said item repositioning mechanism slides said first item from a position adjacent a top surface of said conveyor onto a weighing surface of said scale.

20. The item weighing apparatus of claim 19, wherein:
said system is adapted to prevent said second item from passing said first item while said item repositioning mechanism slides said first item from said weighing surface of said scale back to a position adjacent said top surface of said conveyor.

21. The item weighing apparatus of claim 20, wherein:
said system is adapted to prevent said second item from passing said first item while said scale weighs said first item.

22. The item weighing apparatus of claim 19, wherein said item weighing apparatus is adapted so that:
said scale weighs said first item in response to said first item being moved onto said weighing surface by said item repositioning mechanism; and
said item repositioning mechanism slides said first item from said weighing surface of said scale back to a position adjacent said top surface of said conveyor in response to said first item being weighed by said scale.

23. A method of weighing a first item in a series of items traveling on a conveyor, wherein:
said first item is downstream, relative to a direction of motion of said conveyor, of a second item of said series of items; and
said method comprises the steps of:
(A) restricting the forward movement of said second item; and
(B) while restricting the forward movement of said second item:
(1) diverting said first item from said conveyor so that said first item is in weighing engagement with a scale;
(2) after said step of diverting said first item so that said first item is in weighing engagement with a scale, and while said first item is in weighing engagement with said scale, weighing said first item; and
(3) after said step of weighing said first item, moving said first item back onto said conveyor.

24. The method of claim 23, wherein said step of restricting the forward movement of said second item comprises braking said second item.

25. The method of claim 23, wherein said step of restricting the forward movement of said second item serves to prevent said second item from passing said second item as said second item during said steps of:
(A) diverting said first item from said conveyor so that said first item is in weighing engagement with a scale;
(B) weighing said first item; and
(C) moving said first item back onto said conveyor.

26. The method of claim 25, wherein:
said first and second items are downstream, relative to a direction of motion of said conveyor, of a third item of said series of items; and
said method further comprises the step of:
(A) restricting the forward movement of said third item; and
(B) while restricting the forward movement of said third item, executing said steps of:
(1) diverting said first item from said conveyor so that said first item is in weighing engagement with a scale;
(2) after said step of diverting said first item so that said first item is in weighing engagement with a scale, and while said first item is in weighing engagement with said scale, weighing said first item; and
(3) after said step of weighing said first item, moving said first item back onto said conveyor.

27. The method of claim 23, wherein:
said step of diverting said first item from said conveyor comprises sliding said first item into weighing engagement with a scale; and
said step of moving said first item back onto said conveyor comprises sliding said first item back onto said conveyor.

28. The method of claim 23, wherein said first and second items are plastic containers.

29. The method of claim 23, wherein said step of diverting said first item from said conveyor so that said first item is in weighing engagement with a scale begins when said first item and second items are positioned in an immediate sequential relationship on said conveyor.

30. The method of claim 23, wherein said method further comprises the step of:
stopping the forward movement of said first item immediately before said step of diverting said first item from said conveyor.
